(19) United States
(12) Patent Application Publication
(10) Pub. No.: US 2026/0266051 A1
(43) Pub. Date: Sep. 10, 2026

(54) PAPER SHEET APPLICATION METHOD FOR CONSTRUCTION PANELS

(71) Applicant: Trade Fabrication Systems Limited, Woolston (GB)

(72) Inventor: Howard M. Morris, Upholland (GB)

(73) Assignee: Trade Fabrication Systems Limited, Woolston (GB)

(21) Appl. No.: 18/875,496

(22) PCT Filed: Jun. 28, 2023
(86) PCT No.: PCT/GB2023/051689

§ 371 Date: Dec. 16, 2024

(30) Foreign Application Priority Data
Jun. 30, 2022 (GB) 2209651.5

(51) Int. Cl. E04C 2/16; B32B 7/12; B32B 21/02; B32B 21/06

(52) U.S. Cl. CPC E04C 2/16; B32B 7/12; B32B 21/02; B32B 21/06; B32B 2250/02

(57) ABSTRACT

The present invention relates to a method of applying a paper sheet to a construction panel wherein a step of bonding the paper sheet to the construction panel is performed. The invention also relates to a paper lined construction panel.

### FIELD OF INVENTION

The present invention relates to a method of applying a paper sheet to a construction panel wherein a step of bonding the paper sheet to the construction panel is performed. The invention also relates to a paper lined construction panel.

### BACKGROUND

Site hoardings are commonly used on construction sites, for example, to enclose building sites during a building process or shop fronts whilst alterations are in progress. These hoardings are often made of plywood construction panels and are frequently decorated with advertising. The artwork for this advertising is often created by painting or printing directly onto the surface of the construction panel.

In recent years, cheaper, more versatile, construction panel materials have been investigated as alternatives to the traditional hoarding materials (e.g. plywood). Such alternatives however do not come without their own issues. In particular, engineered wood constructional panels such as Oriented Strand Board (sometimes referred to herein as OSB) have attracted much interest in the hoarding industry. Whilst these panels are generally less expensive, more versatile and environmentally friendly, they can often possess an uneven outer surface which can sometimes cause downstream processing issues. OSB and Waferboard are engineered wood-based materials in which in strands (or strips) of wood are bonded together with a synthetic resin adhesive. The wood strands typically lie unevenly across each other but, depending the material requirements, can be predominantly orientated in a particular direction. With these type of panels, the overlapping of the wood strands within the structure of panel material surface creates the problematic uneven outer surface.

One problem associated with panels that have an uneven outer surface, like OSB and Waferboard, is that the uneven outer surface of the panels have a poor aesthetic appearance and are difficult to decorate. In order to overcome this issue, manufacturers have attempted to adhere paper sheets (also referred to herein as paper liners) to the surface of these construction panels to enhance panel appearance and provide a surface that can be more easily decorated (e.g. painted on or printed on). The present inventors have established that when attempting to permanently apply a paper sheet to the surface of such panels, however, it is difficult to form an evenly distributed adhesive bond between the uneven outer surface of the construction panels and the paper sheet. This is exemplified in FIG. 1 (S3) and FIG. 2 (S15) wherein only certain portions of the construction panel surface are directly adhered to the paper sheet. In addition, the uneven contours forming part of the outer surface of these panels are often also still visible through the paper sheet which reduces the aesthetic appearance of the panels. Moreover, for certain construction panels, wood strands forming part of the panel surface can splinter through the paper sheet causing a safety hazard for installers and users.

It has also been found that some construction panels, such as OSB and Waferboard, are susceptible to moisture uptake when stored and transported. This causes thickening and swelling of certain portions of the panels (e.g. edge portions) which can make the panels difficult to process and sometime result in panels of varying thicknesses being produced. This swelling of the edge portions of the panel is illustrated in FIG. 3 (S13). This can have major cost implications for the builders, as well as the safety of constructed structures and the construction industry as a whole.

It is an object of the present invention to obviate or mitigate at least one or more of the above-mentioned disadvantages.

### SUMMARY OF THE INVENTION

In general, the present invention proposes a unique method of applying a paper sheet to a construction panel which has an initial uneven outer surface (e.g. OSB, Waferboard etc) to provide a paper lined panel with enhanced functionality and utility. The method involves processing a construction panel to modify an uneven outer surface of the construction panel in order to provide a uniform outer surface and/or a substantially uniform thickness across the entire construction panel before bonding a paper sheet to the construction panel. It has been advantageously established that this method successfully creates a smoothened surface, permanently bonded, paper-lined construction panel from construction materials which are traditionally problematic to use within the decorative hoarding and flooring application space (e.g. OSB and Waferboard).

In a first aspect of the present invention there is provided a method of applying a paper sheet to a construction panel, the construction panel comprising an uneven outer surface, wherein the method comprises the steps of (a) processing the construction panel to modify the uneven outer surface to provide (i) a uniform outer surface; and/or (ii) a substantially uniform thickness across the entire construction panel, (b) applying an adhesive composition to the uniform outer surface to provide a construction panel bonding surface and/or applying an adhesive composition to the paper sheet to provide a paper bonding surface, and (c) bonding the paper sheet to the construction panel.

The present invention relates to a method of applying a paper sheet to a construction panel. It will be appreciated that the method of applying the paper sheet to the construction panel will, in some embodiments, result in the paper sheet being permanently bonded to the construction panel. In other embodiments, the method of applying the paper sheet to the construction panel will result in the paper sheet being temporarily bonded to the construction panel. In embodiments, wherein the paper sheet is permanently bonded to the construction panel, it is intended that the paper sheet cannot be easily removed during use (e.g. the paper sheet cannot be easily removed by the user or weathering). Where the paper sheet is temporarily bonded to the construction panel, it is envisaged that the user can easily remove the paper sheet from the construction panel during use. It will be understood that, where the construction panels are intended for hoarding applications, the paper sheet is preferably permanently bonded to the surface of the construction panel.

The term “construction panel” is intended to indicate a structural building element suitable for use in the construction of a building, hoarding system or alike. The panel is typically square or rectangular in shape. Where the construction panel is rectangular in shape, there is a long edge, a short edge, a top surface, a width defined by a measurement extending orthogonally from one long edge across the top surface to the other long edge and a length defined by a measurement extending orthogonally from one short edge across the top surface to the other short edge. Where the construction panel is a square, the edges of the panel will be equal in length and its width is defined by a measurement extending orthogonally across a top surface between opposing edges. Typically, the construction panels may have a panel width of from about 300 mm to about 1400 mm, panel length of from about 1000 mm to about 5000 mm and a panel height/thickness of from about 3 mm to about 100 mm. More preferably, the construction panels may have a panel width of about 600 mm, panel length of from about 2400 mm and a panel height/thickness of about 22 mm. In some embodiments, the construction panels may have a panel height/thickness of from about 3 mm to about 100 mm, from about 10 mm to about 100 mm, from about 20 mm to about 100 mm, from about 30 mm to about 100 mm, from about 40 mm to about 100 mm, from about 50 mm to about 100 mm, from about 60 mm to about 100 mm, from about 70 mm to about 100 mm, from about 80 mm to about 100 mm, from about 10 mm to about 90 mm, from about 10 mm to about 80 mm, from about 10 mm to about 70 mm, from about 10 mm to about 60 mm, from about 10 mm to about 50 mm, from about 10 mm to about 40 mm, from about 10 mm to about 30 mm, from about 20 mm to about 50 mm, from about 10 mm to about 40 mm or from about 20 mm to about 40 mm.

The construction panels may also include a suitable installation system which allows separate construction panels to be connected to one another in order to form a larger surface, such as a floor, hoarding system, ceiling or roof. For example, the construction panels may include tongue and groove profiled edges to allow for the connecting of separate panels together. In embodiments, where the construction panel is for use in a hoarding system, typically, the construction panel may have a panel width of from about 300 mm to about 5000 mm, panel length of from about 1000 mm to about 5000 mm and a panel height/thickness of from about 0.1 mm to about 100 mm.

It will be appreciated that, as used herein, the term “surface” may refer to a top surface and/or bottom surface of a construction panel but does not include the outward facing edges of the construction panel.

According the first aspect of the present invention, the construction panel comprises an uneven outer surface. By this, it is intended to indicate that the surface of the construction panel is a potholed, rutted, splintered, unevenly contoured surface or any combination thereof. The uneven outer surface may generally be difficult to decorate by conventional means (e.g. painting or paper-lining). Examples of construction panels having an uneven outer surface include, but are not limited to, OSB and Waferboard. An exemplary uneven outer surface can be seen depicted in FIG. 1 (see surface (3) in S1), FIG. 2 (see surface (13) in S11) and FIG. 3 (see surface (23a) and (23b)).

In embodiments, the uneven outer surface comprises overlapping wood strands and a plurality of recesses formed between the overlapping wood strands. It will be appreciated that the overlapping wood strands and plurality of recesses create an unevenly contoured surface of the construction panel.

The term “recess” or “recesses” is intended to indicate an unfilled gap, void, pit or depression present in the panel surface. In particular, a void that extends into the construction panel from an outer surface of the construction panel. The outer surface may be defined by the plane formed from the exposed surfaces of the uppermost wood strands in the outer layer construction panel. For avoidance of doubt, such recesses do not contain any wood material or resin and arise due to the overlapping orientation of the wood strands forming the outer layer. It will be appreciated that any construction panel possessing an uneven outer surface is covered by the scope of the present invention, this includes chipboard. Whilst the recesses described herein do not occur in chipboard due to the small size of the wood chips and the large amount of resin used to bind the wood chips together in chipboard, it is envisaged that chipboard panels with poorly finished, unevenly contoured, surfaces also form an embodiment of the present invention.

The term “wood strand” is intended to indicate single elongated fragment composed of a wood material. Wood strands are also commonly referred to as wood flakes. The strands may be of any elongated shape, such as rectangular or triangular. In some embodiments, the wood strands are an elongated irregular shape. It will be appreciated that the strands are larger than woodchips commonly used in chipboard (also known as particleboard). It will also be appreciated that size of the wood strands can be defined by their length, width and thickness, where the length corresponds to their longest dimension. Typically, the length will correspond to the grain direction of the wood while the width runs across the grain.

In embodiments, the wood strands have a length of from about 25 mm to about 250 mm. In some embodiments, the wood strands have a length of from about 40 mm to about 250 mm, from about 60 mm to about 250 mm, from about 75 mm to about 250 mm, from about 25 mm to about 200 mm, from about 25 mm to about 150 mm, from about 25 mm to about 100 mm, from about 25 mm to about 75 mm, from about 30 mm to about 200 mm, from about 40 mm to about 175 mm, from about 50 mm to about 150 mm, from about 50 mm to about 100 mm, from about 50 mm to about 75 mm. Preferably, the wood strands have a length of from about 50 mm to about 150 mm.

In embodiments, the wood strands have a width of from about 2.5 mm to about 75 mm. In some embodiments, the wood strands have a width of from about 5 mm to about 75 mm, from about 10 mm to about 75 mm, from about 15 mm to about 75 mm, from about 2.5 mm to about 50 mm, from about 2.5 mm to about 40 mm, from about 5 mm to about 75 mm, from about 10 mm to about 75 mm, from about 15 mm to about 75 mm, from about 15 mm to about 50 mm, from about 10 mm to about 40 mm, from about 15 mm to about 40 mm. Preferably, the wood strands have a width of from about 5 mm to about 50 mm.

In embodiments, the wood stands have a length of from about 25 mm to about 250 mm and a width of from about 2.5 mm to about 75 mm. In further embodiments, wood stands have a length of from about 50 mm to about 200 mm and a width of from about 5 mm to about 50 mm. In still further embodiments, the wood stands have a length of from about 50 mm to about 150 mm and a width of from about 10 mm to about 40 mm.

In embodiments, the wood strands have a thickness of from about 0.05 mm to about 2 mm, In some embodiments, the wood strands have a thickness of from about 0.1 mm to about 2 mm, from about 0.2 mm to about 2 mm, from about 0.3 mm to about 2 mm, from about 0.05 mm to about 1.5 mm, from about 0.05 mm to about 1 mm, from about 0.05 mm to about 0.7 mm, from about 0.1 mm to about 1.5 mm, from about 0.2 mm to about 1 mm, from about 0.3 mm to about 1 mm, from about 0.3 mm to about 0.7 mm. Preferably, the wood strands have a width of from about 0.2 mm to about 1 mm.

In embodiments, the wood stands have a length of from about 25 mm to about 250 mm, a width of from about 2.5 mm to about 75 mm and a thickness of from about 0.05 mm to about 2 mm. In other embodiments, the wood stands have a length of from about 50 mm to about 200 mm, a width of from about 5 mm to about 50 mm and a thickness of from about 0.1 mm to about 1 mm. In further embodiments, the wood stands have a length of from about 50 mm to about 150 mm, a width of from about 10 mm to about 40 mm and a thickness of from about 0.2 mm to about 1 mm.

In embodiments of the present invention, the plurality of recesses formed between the overlapping wood strands in the outer layer have a depth of from about 0.25 mm to about 20 mm or from about 0.5 mm to about 20 mm, e.g. of from about 1 mm to about 10 mm, such as, of from about 2 mm to about 8 mm. Preferably, the plurality of recesses in the outer layer have a depth of from about 1 mm to about 20 mm, from about 1 mm to about 15 mm, from about 5 mm to about 20 mm, from about 10 mm to about 20 mm. In embodiments, the plurality of recesses in the outer layer have a depth of from about 2 mm to about 10 mm, from about 3 mm to about 10 mm, from about 4 mm to about 10 mm, from about 5 mm to about 10 mm, from about 6 mm to about 10 mm, from about 8 mm to about 10 mm, from about 2 mm to about 9 mm, from about 2 mm to about 8 mm, from about 2 mm to about 7 mm, from about 2 mm to about 6 mm or from about 2 mm to about 4 mm or from about 3 mm to about 7 mm. Even more preferably, the plurality of recesses in the outer layer have a depth of from about 4 mm to about 6 mm. The depth of the recesses refers to the maximum distance the recess extends into the construction panel from the outer surface of the construction panel. It will be appreciated that the recess depths described herein are commonly found in engineered wood materials comprising overlapping wood strands, such as Oriented Strand Board or Waferboard.

It will be appreciated that, in some embodiments, that the depth of the recesses described herein is decreased upon performing the step of processing the construction panel. For example, where the step of processing the construction panel includes a step of sanding the uneven outer surface (e.g. calibration sanding and/or finishing sanding), the depth of the recesses forming part of the uneven outer surface is decreased as a result of panel material being removed from the outer surface (e.g. abraded away) during the sanding process. In embodiments, the decrease in the depth of the recesses forming part of the uneven outer surface is from about 0.05 mm to about 5 mm or about 0.1 mm to about 1 mm. In other embodiments, the decrease in the depth of the recesses forming part of the uneven outer surface is from about 0.2 mm to about 1 mm, from about 0.3 mm to about 1 mm, from about 0.4 mm to about 1 mm, from about 0.5 mm to about 1 mm, from about 0.1 mm to about 0.9 mm, from about 0.1 mm to about 0.8 mm, from about 0.1 mm to about 0.7 mm, from about 0.1 mm to about 0.6 mm or from about 0.1 mm to about 0.5 mm. In embodiments, the plurality of recesses in the uneven outer surface have a depth of from about 0.5 mm to about 20 mm and wherein the depth is decreased upon performing the step of processing the construction panel (e.g. the decrease in the depth of the recesses forming part of the uneven outer surface is from about 0.1 mm to about 1 mm upon).

In embodiments of the present invention, the overlapping wood strands are selected from any suitable type of wood strand or a combination of one or more suitable types of suitable wood strand. In other embodiments, the overlapping wood strands are selected from the group consisting of spruce wood strands, fir wood strands, pine wood strands, larch wood strands, beech wood strands, aspen wood strands, birch wood strands, willow wood strands, alder wood strand or any combination thereof. In embodiments, the wood strands comprise recycled timber.

In embodiments, the construction panel is OSB or Waferboard. For example, the construction panel may be any type of OSB as defined by European Standard EN300 (OSB—Definitions, classification and specifications). OSB is considered to be one of the most viable replacement materials for the plywood panels commonly used as construction panels. OSB panels also show highly favourable mechanical properties that make it particularly suitable for load bearing applications in construction. As described herein, the present inventors have identified issues related to the application of paper materials to OSB based panels. The present invention has been observed to be particularly effective for overcoming this disadvantage when utilising OSB construction panels. In other embodiments of the present invention, the construction panel is a non-Orientated Strand Board, for example, Waferboard.

According to the first aspect of the present invention and embodiments thereof, the method includes a step of processing the construction panel to modify the uneven outer surface to provide a uniform outer surface and/or a substantially uniform thickness across the entire construction panel.

It will be appreciated that the term “uniform outer surface” is intended to indicate a surface of the construction panel that is substantially flat and smooth. That is, it will be understood that the uniform outer surface has undergone a step of processing in order to remove a potholed, splintered and/or unevenly contoured surface. The uniform outer surface will be suitable for bonding a paper sheet in order to create a uniform, smooth and substantially flat paper-lined panel surface. The paper-lined surface will be easily decorated (e.g. painted) to provide an aesthetic finish.

It will be appreciated that by “substantially uniform thickness across the entire construction panel” it is meant that the construction panel undergoing the step of processing results in a thickness variation that is minimised to the extent that the uniformity of adhesive composition application step and bonding of a paper sheet step is not compromised. In some embodiments, the step of processing the construction panel to modify the uneven outer surface includes removing swollen/thickened edge portions of the construction panel. This removes downstream issues associated with construction panel which have non-uniform thickness profiles. Such issues include panels becoming stuck within production line machinery or facilities due to the panel having an undesired thickness profile (e.g, wherein the construction panel thickness exceeds the production line machinery tolerance limits).

In some embodiments, the method includes processing the construction panel to modify the uneven outer surface to provide a substantially uniform thickness across the entire construction panel wherein the thickness across the entire construction panel has a variance of from about ±0.1 mm to about ±5 mm, from about ±0.1 mm to about ±1 mm, from about ±0.1 mm to about ±0.5 mm, from about ±1 mm to about ±5 mm, or from about ±3 mm to about ±1 mm. Preferably, the method includes processing the construction panel to modify the uneven outer surface to provide a substantially uniform thickness across the entire construction panel wherein the thickness across the entire construction panel has a variance of from about ±0.1 mm to about ±1 mm.

In embodiments, there is a step of processing the construction panel to modify the uneven outer surface to provide a uniform outer surface only. In other embodiments, there is a step of processing the construction panel to modify the uneven outer surface to provide a substantially uniform thickness across the entire construction panel only. In further embodiments, there is a step of processing the construction panel to modify the uneven outer surface to provide a uniform outer surface and a substantially uniform thickness across the entire construction panel. It is will be appreciated that where both a uniform outer surface and a substantially uniform thickness across the entire construction panel are achieved, the step of processing may include a single step (e.g. a single calibration sanding step) or two or more steps (e.g. a calibration sanding step followed by a finishing sanding).

According to the first aspect of the present invention and embodiments thereof, there is a step of applying an adhesive composition to the uniform outer surface to provide a construction panel bonding surface and/or applying an adhesive composition to the paper sheet to provide a paper bonding surface.

The term “adhesive composition” is intended to indicate any substance applied to a surface of one, or both, of two separate articles (e.g. a uniform outer surface of construction panel or a surface of a paper sheet) to bond them together to resist their separation. As it will be appreciated, the term “bond” or “bonding” refers to the fixing or securing of two separate surfaces together. This may include the formation of covalent bonds, ionic bonds, dipole-dipole bonding, hydrogen-bonding, Van der Waal forces or alike. A “bonding surface” as referred to herein represents a surface suitable for securing the paper sheet to the construction panel as described herein. The term “adhesive composition” may be used interchangeably with the term “adhesive” for the purposes of this invention.

In embodiments, there is a step of applying an adhesive composition to the uniform outer surface to provide a construction panel bonding surface and also applying an adhesive composition to the paper sheet to provide a paper bonding surface. It is however appreciated that only one of a construction panel bonding surface or a paper bonding surface may be formed in order to provide a suitably strong bond between the panel surface and paper sheet. Typically, the method includes a step of applying an adhesive composition to the uniform outer surface to provide a construction panel bonding surface.

According to the first aspect of the present invention and embodiments thereof there is a step of bonding the paper sheet to the construction panel. It will be appreciated that bonding may include any means suitable for adhering the construction panel to the paper sheet. This can include bonding by pressure activation (e.g. using pressure sensitive adhesives), heat activation, photo-chemical activation, chemical activation or the like. The bonding step typically involves bringing the construction panel bonding surface in contact with the paper sheet or bringing the paper bonding surface into contact with the construction panel. In embodiments, bonding the paper sheet to the construction panel comprises applying the paper sheet to the construction panel bonding surface.

In embodiments the method steps are performed continuously, optionally, where the step of applying an adhesive composition to the uniform outer surface to provide the construction panel bonding surface is performed less than 30 minutes after the step of processing the construction panel. It will be appreciated that in such embodiments the method steps may be performed using a single production line system located within a single location. In some embodiments, the step of applying an adhesive composition to the uniform outer surface to provide the construction panel bonding surface or applying an adhesive composition to the paper to provide the paper bonding surface will be performed directly after the step of processing the construction panel. For example, the step of applying an adhesive composition to the uniform outer surface to provide the construction panel bonding surface or applying an adhesive composition to the paper to provide the paper bonding surface will be performed less than 24 hours after the step of processing the construction panel, less than 12 hours after the step of processing the construction panel, less than 6 hours after the step of processing the construction panel, less than 3 hours after the step of processing the construction panel, less than 1 hour after the step of processing the construction panel, less than 30 minutes hours after the step of processing the construction panel, less than 15 minutes after the step of processing the construction panel, less than 5 minutes after the step of processing the construction panel, less than 1 minute after the step of processing the construction panel, less than 30 seconds after the step of processing the construction panel or less than 10 seconds after the step of processing the construction panel.

In some embodiments, the step of processing the construction panel may include one or more sanding steps (e.g. a calibration sanding step followed by a finishing sanding step) as described herein. In such embodiments, the step of applying an adhesive composition to the uniform outer surface to provide the construction panel bonding surface or applying an adhesive composition to the paper to provide the paper bonding surface is performed in a time period short enough to prevent distortion (e.g. warping, bending, swelling etc) of the construction panel before the step of bonding the paper sheet to the construction panel is performed. For example, in some embodiments, it is necessary to ensure that the construction panel does not absorb a sufficient amount of moisture/water from its surrounding environment such that an undesirable variance in the thickness profile of the construction panel occurs before adhesive application and bonding is performed. This can occur when using certain construction panel materials, such as OSB and Waferboard, which are susceptible to moisture uptake when stored and transported between processing steps.

In accordance with the first aspect of the present invention or embodiments thereof, the step of applying an adhesive composition to the uniform outer surface to provide a construction panel bonding surface may comprise spraying, brushing, trowelling, bead-jetting, nozzle dispensing, roller coating (e.g. reverse or forward roller coating), curtain coating, solid application or any combination thereof the adhesive composition to the uniform outer surface to provide a construction panel bonding surface.

In accordance with the first aspect of the present invention or embodiments thereof, the step of applying an adhesive composition to the paper sheet to provide a paper bonding surface may comprise spraying, brushing, trowelling, bead-jetting, nozzle dispensing, roller coating (e.g. reverse or forward roller coating), curtain coating, solid application or any combination thereof the adhesive composition to provide a paper bonding surface.

In preferred embodiments of the present invention, the step of applying an adhesive composition, as described herein, comprises roller coating, for example, reverse roller coating. The above methods provide a means for applying a smooth consistent layer of adhesive onto the uniform outer surface of the constructions panel, or the surface of the paper sheet, so as to generate a suitable bonding surface. The method also allows for the control of the coat weight of adhesive composition being applied, which is important in achieving a permanent, or sufficient but temporary adhesion, of the construction panel to the paper sheet depending on the construction application requirements.

In embodiments, the adhesive composition is applied to the uniform outer surface to provide a construction panel bonding surface at a coat weight of from about 20 to about 150 grams per square metre, preferably at a coat weight of from about 60 to about 100 grams per square metre. In other embodiments, the adhesive composition is applied at a coat weight of from about 10 to about 250 grams per square metre, from about 50 to about 250 grams per square metre, from about 100 to about 250 grams per square metre, from about 150 to about 250 grams per square metre, from about 200 to about 250 grams per square metre, from about 10 to about 200 grams per square metre, from about 10 to about 200 grams per square metre, from about 10 to about 150 or from about 10 to about 100 grams per square metre grams per square metre.

In embodiments, the adhesive composition is applied to the paper sheet to provide a paper bonding surface at a coat weight of from about 20 to about 150 grams per square metre, preferably at a coat weight of from about 60 to about 100 grams per square metre. In other embodiments, the adhesive composition is applied at a coat weight of from about 10 to about 250 grams per square metre, from about 50 to about 250 grams per square metre, from about 100 to about 250 grams per square metre, from about 150 to about 250 grams per square metre, from about 200 to about 250 grams per square metre, from about 10 to about 200 grams per square metre, from about 10 to about 200 grams per square metre, from about 10 to about 150 or from about 10 to about 100 grams per square metre grams per square metre.

In further embodiments, the step of applying the adhesive to the uniform outer surface to provide a construction panel bonding surface and/or applying an adhesive composition to the paper sheet to provide a paper bonding surface may be performed at an elevated temperature. Suitable temperatures may depend on the type of adhesive composition(s) being used and may include, but are not limited to, a temperature of from about 50° C. to about 200° C., from about 50° C. to about 150° C., from about 100° C. to about 200° C., from about 120° C. to about 180° C., from about 40° C. to about 160° C. Typically, the temperature of the further adhesive composition may be from about 125° C. to about 175° C. or from about 80° C. to about 150° C. For example, the step of applying the adhesive composition to the uniform outer surface of the construction panel may be performed at a temperature of about 150° C. In some embodiments, applying the adhesive composition to the uniform outer surface is performed at a temperature of from about 50° C. to about 150° C. In such embodiments, the adhesive may be a hot melt adhesive as described herein.

In still further embodiments, the uniform outer surface of the construction panel has an elevated temperature prior to the step of applying the adhesive composition. This is useful in overcoming problems/issues associated with applying hot melt adhesives to the uniform outer surface wherein the uniform outer surface is at ambient temperature. For example, increasing the temperature of the uniform outer surface to which the adhesive is to be applied may prevent stringing of the adhesive composition during application. The degree of temperature elevation will depend on the adhesive being used. Suitable temperatures at which to elevate the uniform outer surface prior to applying an adhesive composition may include a temperature of from about 5° C. to about 60° C., more preferably from about 40° C. to about 60° C. The uniform outer surface may be heated using any suitable heating means, for example, radiant gas heaters.

Suitable adhesive compositions may include, but are not limited to, a hot melt adhesive, drying adhesive, pressure sensitive adhesive, contact adhesives or any combination thereof.

In some embodiments, the adhesive composition is a hot melt adhesive; optionally when the adhesive composition is hot melt adhesive the adhesive composition may include waxes, resins, ethylene-vinyl acetate copolymers, polyolefins, polyamides, polyesters, polyurethanes, styrene block copolymers, polycaprolactones, polycarbonates, fluorinated polymers, silicone based polymers, polypyrroles or any combination thereof.

Advantageously, hot melt adhesives have been found to be effective at penetrating into and filling the recesses between the wood strands in the construction panels, thereby generating a uniform bonding surface.

Preferably, the adhesive composition is an ethylene-vinyl acetate copolymer based adhesive optionally wherein the viscosity of the ethylene-vinyl acetate copolymer based adhesive is from about 1000 to about 3100 cPs@160° C., from about 1000 to about 1500 cPs@170° C., from about 1500 to about 2500 cPs@150° C. or from about 1500 to about 2500 cPs@180° C.

Examples of the adhesive compositions used to bond a paper sheet to a construction panel including their respective suppliers, grades and viscosity measurements, are as illustrated in the Table 1 below.

| Supplier | Grade | Viscosity |
|---|---|---|
| Abrabond ™ | AB464HM | 1700 cPs @ 160° C. |
| Adhesives direct ™ | AD826 | 1750 cPs @ 160° C. |
| Adhesives direct ™ | AD851 | 1900 cPs @ 160° C. |
| Alphabond Adhesives ™ | Fastlock 66x | 1850 cPs @ 160° C. |
| Alphabond Adhesives ™ | Fastlock 30029 | 1700 cPs @ 160° C. |
| Beardow Adams ™ | Prodas 2308 | 1795 cPs @ 160° C. |
| Beardow Adams ™ | Prodas 1507 | 1700 cPs @ 160° C. |
| Beardow Adams ™ | Prodas 2247 | 3080 cPs @ 160° C. |
| Bostik ™ | Thermogrip 9691 | 1300 cPs @ 170° C. |
| Caswell Adhesives ™ | Premiermelt 178PA | 1450 cPs @ 160° C. |
| Colquimica ™ | K-melt C2310 | 1000 cPs @ 160° C. |
| HB Fuller ™ | Swift-therm 9119 | 2200 cPs @ 150° C. |
| Jowat Adhesives ™ | Jowatherm 261.40 | 1800 cPs @ 180° C. |

In embodiments of the present invention, the adhesive composition is a UV (ultra violet) curable adhesive. A UV curable adhesive is one which hardens under irradiation of UV (ultraviolet) light. For example, the curing may occur by the UV light initiating a photochemical reaction that generates a cross-linked network of polymers.

For avoidance of doubt, a hot melt adhesive may also be a UV curable adhesive. For example, the adhesive may be applied hot and partially set upon cooling but then further harden under UV irradiation.

Where the adhesive composition is a UV curable adhesive, the method preferably comprises a step of curing the UV curable adhesive. The step of curing the UV curable adhesive may involve irradiating the first adhesive composition with UV light, e.g. using a UV lamp.

It will be appreciated that paper sheet may be any paper based sheet material suitable for bonding to and lining the surface of a construction panel. In embodiments, the paper sheet is a building paper sheet or kraft paper sheet. Examples of suitable building paper include Arclin® Guardsman™, Arclin® 4600, Arclin ReadyPrime 4047®, and Arctek® Dryshell™.

In embodiments, the paper sheet (e.g. building paper sheet) has a weight of from about 50 grams per square metre to about 400 grams per square metre and/or a thickness of from about 0.1 mm to about 2 mm.

In further embodiments, the paper sheet has a weight of from about 50 grams per square metre to about 400 grams per square metre, from about 100 grams per square metre to about 400 grams per square metre, from about 150 grams per square metre to about 400 grams per square metre, from about 200 grams per square metre to about 400 grams per square metre, from about 250 grams per square metre to about 400 grams per square metre, from about 50 grams per square metre to about 250 grams per square metre, from about 50 grams per square metre to about 200 grams per square metre, from about 50 grams per square metre to about 150 grams per square metre, from about 50 grams per square metre to about 100 grams per square metre, from about 100 grams per square metre to about 200 grams per square metre, from about 150 grams per square metre to about 250 grams per square metre or from about 200 grams per square metre to about 250 grams per square metre. In some embodiments, the paper sheet has a weight of from about 100 grams per square metre to about 400 grams per square metre, the paper sheet has a weight of from about 250 grams per square metre to about 350 grams per square metre or the paper sheet has a weight of from about 300 grams per square metre to about 350 grams per square metre.

In embodiments, the paper sheet has a thickness of from about 0.1 mm to about 2 mm, from about 0.5 mm to about 2 mm, from about 1 mm to about 2 mm, from about 1.5 mm to about 2 mm, from about 0.1 mm to about 1.5 mm, from about 0.1 mm to about 1 mm, from about 0.1 mm to about 0.9 mm, from about 0.1 mm to about 0.8 mm, from about 0.1 mm to about 0.7 mm, from about 0.1 mm to about 0.6 mm, from about 0.1 mm to about 0.5 mm, from about 0.2 mm to about 1 mm, from about 0.3 mm to about 1 mm, from about 0.4 mm to about 1 mm, from about 0.5 mm to about 1 mm or from about 0.3 mm to about 0.7 mm.

According to the first aspect of the present invention and embodiments thereof, the method includes a step of processing the construction panel to modify the uneven outer surface to provide a uniform outer surface and/or a substantially uniform thickness across the entire construction panel.

In embodiments, the step of processing the construction panel to modify the uneven outer surface to provide a uniform outer surface and/or a substantially uniform thickness across the entire construction panel comprises sanding the uneven outer surface. It will be appreciated that sanding may include one or more sanding so as to achieve a uniform outer surface and/or a substantially uniform thickness across the entire construction panel. Preferably, the step of sanding provides both a uniform outer surface and a substantially uniform thickness across the entire construction panel.

In embodiments, the step of sanding comprises performing a step of calibration sanding. The step of calibration sanding may be performed using a sanding paper having a grit size of from about 60 to about 100, from about 70 to about 90, preferably, a grit size of from about 60 to about 80. In such embodiments, there may be an optional step of finishing sanding. The step of finishing sanding may be performed using a sanding paper having a grit size of from about 240 to about 280, about 250 to about 270, preferably, a grit size of about 260 to about 280.

In embodiments, the step of sanding may result in the thickness of the construction panel being reduced by from about 0.1 mm to about 1 mm. It will be appreciated that, in such embodiments, whilst the step of sanding may result in the thickness of the construction panel being reduced, the construction panel is also be modified to provide a substantially uniform thickness across the entire construction panel as described herein.

In embodiments, the step of sanding is performed using as single head sander, two head sander or a three head sander. In some embodiments, the step of sanding is performed using a wide belt sander.

In embodiments, applying the paper sheet to the construction panel bonding surface to bond the paper sheet to construction panel comprises applying a pressure of from about 20 kPA to about 800 kPa to the paper sheet. In some embodiments, applying the paper sheet to the construction panel bonding surface to bond the paper sheet to construction panel comprises applying a pressure of from about 100 kPa to about 700 kPa, from about 200 kPa to about 700 kPa, from about 300 kPa to about 600 kPa, from about 350 kPa to about 550 kPa to the paper sheet or, more preferably, a pressure of from about 400 kPa to about 500 kPa. Even more preferably, applying the paper sheet to the construction panel bonding surface to bond the paper sheet to construction panel comprises applying a pressure of from about 400 kPa, about 450 kPa or about 500 kPa to the paper sheet.

In embodiments, applying the paper sheet to the construction panel bonding surface to bond the paper sheet to construction panel comprises applying a pressure of from about 20 kPA to about 2500 kPa to the paper sheet. In some embodiments, applying the paper sheet to the construction panel bonding surface to bond the paper sheet to construction panel comprises applying a pressure of from about 100 kPa to about 1500 kPa, from about 200 kPa to about 2000 kPa, from about 1000 kPa to about 1500 kPa, from about 1500 kPa to about 2000 kPa to the paper sheet or, more preferably, a pressure of from about 1000 kPa to about 2000 kPa. Even more preferably, applying the paper sheet to the construction panel bonding surface to bond the paper sheet to construction panel comprises applying a pressure of from about 1200 kPa, about 1600 kPa or about 1500 kPa to the paper sheet.

The pressure can be applied using any suitable pressure applying means, for example, press down rubber wheels or pressure plates.

In embodiments, the method further comprising the step of selectively applying a further adhesive composition to a peripheral region of the construction panel bonding surface and/or selectively applying a further adhesive composition to a peripheral region of the paper sheet bonding surface before applying the paper sheet to the construction panel.

As used herein, the term “selectively applying” refers to a focused application of an adhesive composition to a specific area on a surface of a construction panel or paper sheet. This may involve precisely controlling the application of the adhesive composition onto the specific area on the surface of the construction panel or paper sheet. This may be achieved using a variety of application techniques including, but not limited to, brushing/trowelling, spraying, bead-jetting, nozzle dispensing, roller coating, curtain coating, solid application or any combination thereof.

As used herein, the term “peripheral region” may refer to an area of the construction panel bonding surface which is, generally, located towards an outermost portion of the construction panel. It will also be appreciated that, where used with reference to a paper sheet, the term “peripheral region” may refer to an area of a surface of a paper sheet which is, generally, located towards an outermost portion of the surface of the paper sheet.

It will also be appreciated that the peripheral region may extend from an edge of the panel and extend partially across the bonding surface. In embodiments, the peripheral region may extend from the edge of the construction panel and across from about 0.1% to about 25% of the width of the construction panel bonding surface. In some embodiments, the peripheral region may extend from the edge of the construction panel and across from about 0.2% to about 10%, from about 0.5% to about 2%, from about 1% to about 5%, from about 1% to about 10%, from about 1% to about 15%, from about 5% to about 10%, from about 5% to about 15%, from about 5% to about 20%, from about 5% to about 25%, from about 10% to about 15%, or from about 10% to about 20% of the width of the construction panel bonding surface.

Alternatively, the peripheral region may be inset from an edge of the panel and extend partially across the construction panel bonding surface. In some embodiments, the peripheral region may be inset from an edge of the panel by a distance of from about 0.05% to about 5% of the width of the construction panel. More preferably, the peripheral region may be inset from an edge of the panel by a distance of from about 0.5% to about 2.5% of the width of the panel.

It will also be understood that the peripheral region may extend from an edge of the paper sheet and extend partially across the paper sheet bonding surface. In embodiments, the peripheral region may extend from the edge of the paper sheet and across from about 0.1% to about 25% of the width of the paper sheet bonding surface. In some embodiments, the peripheral region may extend from the edge of the paper sheet and across from about 0.2% to about 10%, from about 0.5% to about 2%, from about 1% to about 5%, from about 1% to about 10%, from about 1% to about 15%, from about 5% to about 10%, from about 5% to about 15%, from about 5% to about 20%, from about 5% to about 25%, from about 10% to about 15%, or from about 10% to about 20% of the width of the paper sheet bonding surface.

Alternatively, the peripheral region may be inset from an edge of the paper sheet and extend partially across the paper sheet bonding surface. In some embodiments, the peripheral region may be inset from an edge of the paper sheet by a distance of from about 0.05% to about 5% of the width of the paper sheet. More preferably, the peripheral region may be inset from an edge of the paper sheet by a distance of from about 0.5% to about 2.5% of the width of the paper sheet.

In some embodiments, the method includes a further step of applying a balancing paper sheet to the construction panel. It will be appreciated the balancing paper sheet is applied and bonded to a surface of the construction panel that is opposite to the surface on which the paper sheet is bonded. For example, if the paper sheet is bonded to a top surface of the construction panel, the method further includes bonding a balancing paper sheet to the bottom surface of the construction panel. The balancing sheet is intended to increase the overall structural stability of the construction panel and prevent warping of the panel, which can sometimes occur when applying a paper sheet to a construction panel as described herein. The application of a balancing paper sheet to the construction panel is especially useful when the construction is to be used for flooring applications.

It will be appreciated that balancing paper sheet may be any paper based sheet material suitable for bonding to and lining the surface of a construction panel. In embodiments, the paper sheet is a building paper sheet or kraft paper sheet. In embodiments, the paper sheet and the balancing paper sheet are the same material. Examples of suitable building paper include Arclin® Guardsman™, Arclin® 4600, Arclin ReadyPrime 4047®, and Arctek® Dryshell™.

It will be appreciated that the step of applying a balancing paper sheet to the construction panel comprises applying an adhesive composition to a surface of the construction panel and/or applying an adhesive composition to the balancing paper sheet before bonding the balancing paper sheet to the construction panel. Where there is step of applying an adhesive composition to a surface of the construction panel before bonding the balancing paper sheet to the construction panel, it will be appreciated that the surface of the construction to which the balancing paper sheet is bonded is a surface opposite to that on which the paper sheet is bonded. For example, if the paper sheet is bonded to a top surface of the construction panel, the surface of the construction panel to which the balancing paper sheet is bonded is the bottom surface.

In accordance with the first aspect of the present invention or embodiments thereof, the step of applying an adhesive composition to a surface of the construction panel before bonding the balancing paper sheet to the construction panel may comprise spraying, brushing, trowelling, bead-jetting, nozzle dispensing, roller coating (e.g. reverse or forward roller coating), curtain coating, solid application or any combination thereof the adhesive composition to the surface of the construction panel. In preferred embodiments of the present invention, the step of applying an adhesive composition to a surface of the construction panel before bonding the balancing paper sheet to the construction panel as described herein comprises roller coating, for example, reverse roller coating.

In embodiments, during the step of applying an adhesive composition to a surface of the construction panel before bonding the balancing paper sheet to the construction panel, the adhesive composition is applied at a coat weight of from about 20 to about 150 grams per square metre, preferably at a coat weight of from about 60 to about 100 grams per square metre. In other embodiments, the adhesive composition is applied at a coat weight of from about 10 to about 250 grams per square metre, from about 50 to about 250 grams per square metre, from about 100 to about 250 grams per square metre, from about 150 to about 250 grams per square metre, from about 200 to about 250 grams per square metre, from about 10 to about 200 grams per square metre, from about 10 to about 200 grams per square metre, from about 10 to about 150 or from about 10 to about 100 grams per square metre grams per square metre.

In further embodiments, the balancing paper sheet has a weight of from about 50 grams per square metre to about 400 grams per square metre, from about 100 grams per square metre to about 400 grams per square metre, from about 150 grams per square metre to about 400 grams per square metre, from about 200 grams per square metre to about 400 grams per square metre, from about 250 grams per square metre to about 400 grams per square metre, from about 50 grams per square metre to about 250 grams per square metre, from about 50 grams per square metre to about 200 grams per square metre, from about 50 grams per square metre to about 150 grams per square metre, from about 50 grams per square metre to about 100 grams per square metre, from about 100 grams per square metre to about 200 grams per square metre, from about 150 grams per square metre to about 250 grams per square metre or from about 200 grams per square metre to about 250 grams per square metre. In some embodiments, the balancing paper sheet has a weight of from about 100 grams per square metre to about 400 grams per square metre, the balancing paper sheet has a weight of from about 250 grams per square metre to about 350 grams per square metre or the balancing paper sheet has a weight of from about 300 grams per square metre to about 350 grams per square metre.

In embodiments, the balancing paper sheet has a thickness of from about 0.1 mm to about 2 mm, from about 0.5 mm to about 2 mm, from about 1 mm to about 2 mm, from about 1.5 mm to about 2 mm, from about 0.1 mm to about 1.5 mm, from about 0.1 mm to about 1 mm, from about 0.1 mm to about 0.9 mm, from about 0.1 mm to about 0.8 mm, from about 0.1 mm to about 0.7 mm, from about 0.1 mm to about 0.6 mm, from about 0.1 mm to about 0.5 mm, from about 0.2 mm to about 1 mm, from about 0.3 mm to about 1 mm, from about 0.4 mm to about 1 mm, from about 0.5 mm to about 1 mm or from about 0.3 mm to about 0.7 mm.

In a second aspect of the present invention there is a protected construction panel obtained or obtainable by the method of the first aspect of the present invention or any embodiment thereof.

In third aspect of the present invention there is a paper lined construction panel comprising an adhesive composition located on a uniform outer surface of the construction panel to form a bonding surface, and a paper sheet located on the bonding surface, wherein the construction panel is OSB or Waferboard and has a substantially uniform thickness across the entire construction panel.

It will be appreciated that other features and embodiments described in relation to the first aspect of the invention may also be applicable to the third aspect of the invention. For the avoidance of doubt, where applicable, all features and embodiments described in relation to the first aspect are intended to be disclosed in relation to the third aspect of the invention. For example, paper lined construction panel may comprise a balancing paper sheet as described in relation to the first aspect wherein the balancing paper sheet is bonded to a surface opposite to the bonding surface.

### BRIEF DESCRIPTION OF FIGURES

Some embodiments of the present invention are described more fully hereinafter with reference to the accompanying figures. In the figures, dimensions may be exaggerated for clarity of illustration.

FIG. 1 shows a process flow diagram illustrating a method, not according to the present invention, for applying a paper sheet to a construction panel. Each step within the flow diagram shows a cross sectional view of the construction panel.

FIG. 2 shows a process flow diagram illustrating an alternative method for applying a paper sheet to a construction panel. Each step within the flow diagram shows a cross sectional view of the construction panel.

FIG. 3 shows a process flow diagram illustrating the steps involved in a method for applying a paper sheet to a construction panel according to an embodiment of the present invention. Each step within the flow diagram shows a cross sectional view of the construction panel.

FIG. 4 shows an exemplary schematic wherein a paper sheet to the surface of a construction panel according to an embodiment of the present invention.

FIG. 5 shows a roller coater used to apply adhesive composition to the surface a construction panel.

In the following detailed description, only certain embodiments of the present invention have been shown and described, simply by way of illustration. As those skilled in the art would realise, the described embodiments may preferably be modified in various different ways, all without departing from the spirit or scope of the present invention. Accordingly, the drawings and description are to be regarded as illustrative in nature and not restrictive.

### DETAILED DESCRIPTION OF THE INVENTION

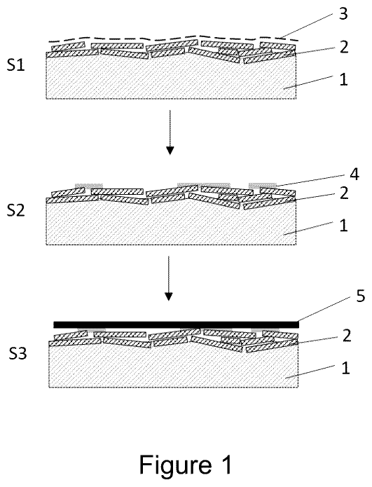

FIG. 1 shows a process flow diagram illustrating a method, which is not according to the present invention, for applying a paper sheet to a construction panel.

At step S1, there is provided a construction panel (1) with an outer surface (3). The outer surface (3) (shown as a broken line) is formed from a plurality of overlapping wood strands (2) which lie unevenly across each other resulting in an uneven (e.g. rough and variegated) surface. The construction panel is, for example, an OSB or Waferboard construction panel.

At step S2, an adhesive composition (4) is applied onto the outer surface of the construction panel using a roller coater. Due to the uneven contours of the outer surface (3), the roller is only able to apply an adhesive composition to the uppermost edges of the protruding wood strands on the outer surface (3). The adhesive composition applied to the outer surface (3) therefore forms an uneven bonding layer.

At step S3, a paper sheet (5) is applied to the adhesive composition (4). Pressure is applied to the paper sheet (4) to ensure bonding between the paper sheet (4) and the construction panel (1). Due to the limited and unevenly distributed coverage of the adhesive composition over the construction panel surface, the strength of the bond between the paper sheet (4) and the construction panel surface is weak. In addition, the pressure applied to the paper sheet (4) during the bonding process also causes the paper sheet to become embossed with the uneven contours formed in the uneven surface outer surface (3). This leads to the resulting paper-lined construction panel possessing a poor surface finish and losing its aesthetic appeal. The method of the present invention seeks to overcome these problems.

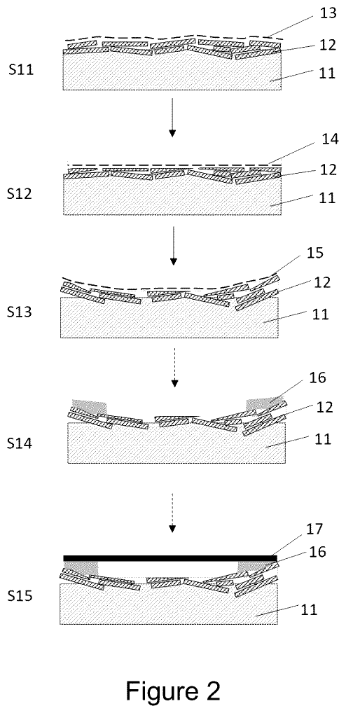

FIG. 2 shows a process flow diagram illustrating another method, not according to the present invention, for applying a paper sheet to a construction panel.

At step S11, there is provided a construction panel (11) with an outer surface (13) (shown as a broken line). Analogous to S1, the outer surface (13) is formed from a plurality of overlapping wood strands (12) which lie unevenly across each other resulting in an uneven (e.g. rough and variegated) surface.

At step S12, the construction panel (11) is modified by performing a sanding step on the outer surface (13), to generate a uniform outer surface (14). The sanding step, in some embodiments, includes a calibration sanding step and finishing sanding step. The calibration sanding step may remove the uppermost, protruding, edges of the overlapping wood strands (12) forming part of the outer surface (13) whilst the finishing sanding step provides an smooth finish on the uniform outer surface.

The present inventors have established that when a construction panel as shown in S12 is stored and/or transported for a prolonged period before the step of applying a paper sheet to the construction panel surface, the panel can become distorted as shown in S13. This generally occurs when the construction panel is left unprotected in moist conditions and exposed to water ingress. The water ingress results in an expansion or thickening at certain portions of the construction panel, particularly at the edges of the panel having a larger surface area exposed to the external environment. This results in the construction panel possessing an uneven surface (15) and a variable thickness along its length. As an example of this is depicted in FIG. 2 at S13.

Step S14 illustrates the poor distribution of adhesive composition to the outer surface when applying an adhesive composition (16) onto the outer surface of the construction panel from S13 using a roller coater. Here, the roller is only able to apply adhesive composition to the raised edges of the construction panel. In some circumstances, depending the nature of the roller coater being used, the distorted panel (shown in S13) is unable to feed into the roller coater thus leading to the production line failure.

At step S15, the paper sheet (17) is applied to adhesive composition (16). Pressure is applied to the paper sheet (4) to ensure it bonds to the construction panel (11). However, in analogy to the FIG. 1, the limited coverage of adhesive over the construction panel surface results in a weak bond being formed. The final product is also likely to be distorted.

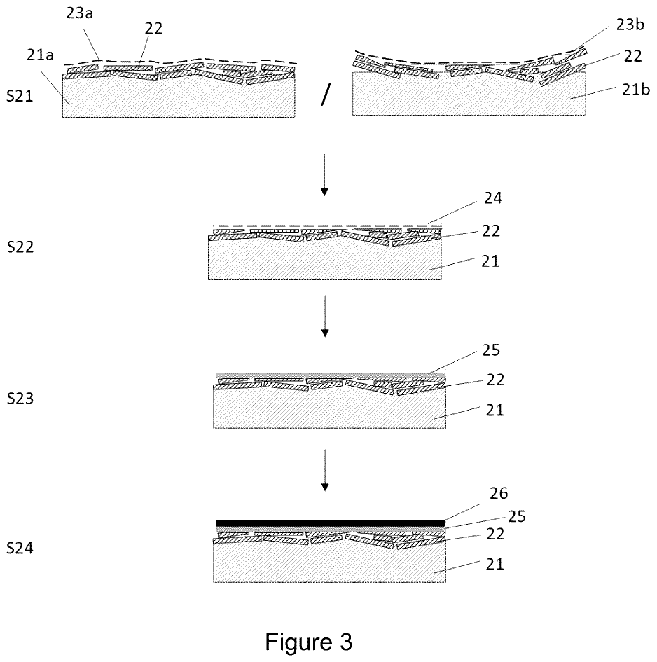

FIG. 3 illustrates a process flow diagram showing a cross sectional view of the surface of a construction panel during an exemplary embodiment of the invention.

At step S21, there is provided a construction panel (21a or 21b) with an uneven outer surface (23a or 23b), for example an OSB or Waferboard construction panel. Outer surface 23a represents a construction panel comprising a plurality of overlapping wood strands (22) that lie unevenly across each other, e.g. an OSB construction panel. Outer surface 23b represents a construction panel, e.g. an OSB construction panel, which has been subject to water ingress.

At step S22, the construction panel (11) is subjected to a sanding step (calibration sanding step and/or finishing sanding step) on its the outer surface (23) to generate a uniform outer surface (24). The sanding step removes protruding parts of the wood strands (22) and ensures that the thickness of the construction panel is uniform.

At step S23, an adhesive composition (25) is applied onto the uniform outer surface (24) of the construction panel to form a bonding surface. This performed directly after the sanding step in a continuous fashion (i.e. the construction panels are conveyed from a sanding apparatus/unit directly to a roller coater where the adhesive composition is applied. This avoid swelling, expansion or thickening of the panel due to ingress of moisture from the surrounding atmosphere.

At step S24, a paper sheet (26) is applied to the adhesive composition. Pressure is typically applied to the paper sheet (26) to ensure bonding to the construction panel (21).

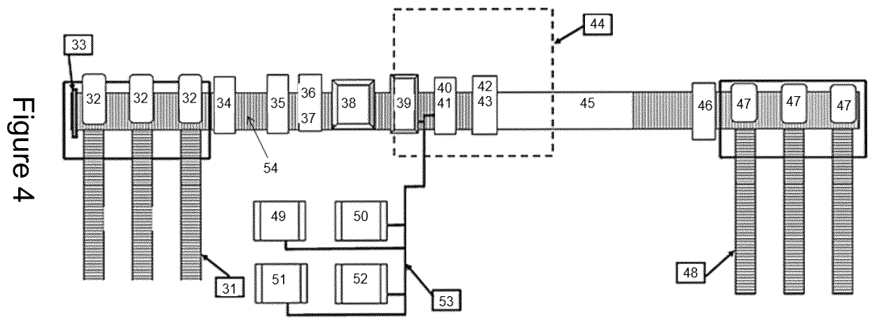

FIG. 4 shows an exemplary schematic wherein a paper sheet is applied to the surface of a construction panel according to an embodiment of the present invention.

Construction panels (not shown) are delivered and loaded on to a feed conveyor system (31). The panels are loaded, using a forklift truck or any other suitable means, onto the feed conveyer system (31) in either single stack or multiple stack arrangements. The feed conveyor system (31) transports the construction panels automatically towards an in-feed vacuum pick-and-place stacking system (32) which in turn transfers the construction panels onto a machine bed (54). Again, the construction panels are loaded on to the machine bed (54), automatically, in either single stack or as multiple stack arrangement.

An in-feed panel pusher (33) then conveys the construction panels along the machine bed (54) and into an in-feed nip roller (34). The construction panels are then automatically conveyed from the in-feed nip roller (34) into a governor roller (35). The governor roller (35) drives the construction panels along the remainder of the machine bed (54) and controls the line speed.

The panels are automatically conveyed from the governor roller (35) into a calibration sander (36) where parts of the top surface of the construction panel are removed to create a construction panel with a uniform top surface. The calibration sander (36) typically has a grit size of 80 but can vary depending on the construction panel material. After calibration sanding, the panel may optionally be conveyed to a finishing sander (37), where the uniform top surface is processed further to produce a smooth finish. The finishing sander (37) typically has a grit size of 80 but can vary depending on the construction panel material. The construction panels are then conveyed through a brush roller (not shown) which cleans the surface of the panels. The brush roller is also fitted with an extraction system to remove any dust on the panel surface. The dust is removed and taken away via an extraction pipe.

The construction panels are then automatically conveyed from the calibration sander (36) and/or finishing sander (37) into a gas radiant heater (38) where the surface of the construction panels is heated to approximately 45° C. From the gas radiant heater station (38), the construction panels are then fed into a heater roller coater (39), where an adhesive composition is applied to the entire top surface of the construction panels. Where the adhesive composition is a hot melt adhesive, heated hoses (53) are used to supply the heater roller coater (39) with the adhesive composition from adhesive melting tanks (49-52).

Optionally, the construction panels may then be automatically conveyed from the heater roller coater (39) into a second heater roller coater (40) and/or a spiral spray head (41) where a further adhesive is applied and/or sprayed over the entire surface of the construction panel. Where the further adhesive composition is a hot melt adhesive, heated hoses (53) are used to supply the second heater roller coater (40) and/or spiral spray head (41) with the adhesive composition from adhesive melting tanks (49-52).

The optional adhesive composition application steps (40) and (41) can be used independently or together depending on the requirements of the construction panel being processed and the types of adhesives used.

The construction panels are then automatically conveyed from the heater roller coater (39) toward a roller (42). A paper sheet is fed from a gantry and forced through a roller holder (44). The paper sheet is then fed around the roller (42) where the paper sheet is bonded to the surface of the construction panels.

The paper-bonded construction panels are then automatically conveyed from the roller (42) into a system of press down rubber wheels (43) to apply pressure to the paper sheet.

The paper-lined construction panels are then automatically conveyed from the pressed down rubber wheels (43) to a cutting/inspection table (45) where any excess paper sheet (e.g. overhanging sheet) is cut along edges of the construction panels with a sharp instrument before the construction panels are quality checked.

The construction panels are then automatically conveyed from the cutting inspection table (45) to an outfeed nip roller (46) which directs the construction panels to an outfeed pick and place stacking system (47) where the panels are restacked on to outfeed conveyors (48) in either single stack or multiple stack arrangements.

The stacks are then then conveyed from the outfeed conveyor (48) to a packing station, preferably via a forklift truck, where the packs are repackaged into their original/alternative packaging.

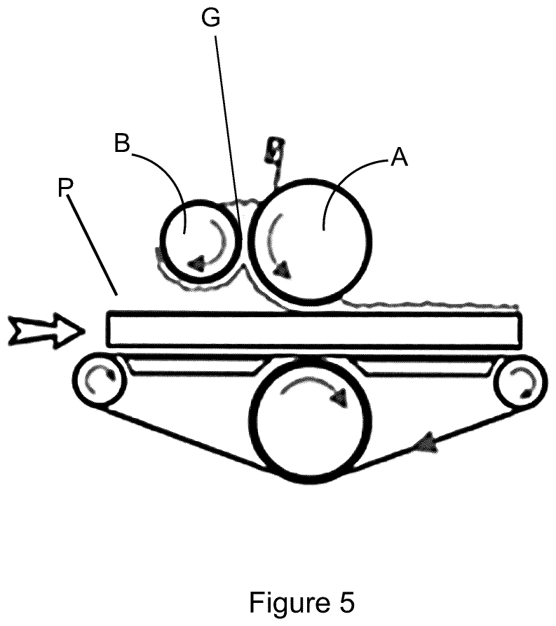

FIG. 5 illustrates an example of the heater roller coater (39) as described above. The heater roller coater is made up of a silicon roller (A) and steel dosing roller (B) which are both oil heated via an electric element that goes through the centre of each of the rollers. Each roller may be independently heated at a temperature ranging from about 80 to about 150° C. depending on the type of adhesive being applied.

A gap (G) between the rollers (i.e. the distance between the silicon roller (A) and the steel dosing roller (B)) is adjusted to control the coat weight of the adhesive composition being applied to the surface of the construction panel. Typically, gaps having measurements of from about 0 mm to about 3 mm are used but, generally, a heavy coat weight can be achieved by using a larger gap as compared to a lighter coat weight. Typical coat weights that can be achieved by the heater roller coater (39) range from about 20 to about 150 grams per square metre depending on the type of adhesive composition being used.

In use, an adhesive composition is pumped onto and into the space between the silicon roller (A) and the steel dosing roller (B). The adhesive composition is retained and prevented from spilling from the sides of the rollers by two pneumatic Teflon™ side plates (not shown) situated at each end of the rollers to create a well. The steel dosing roller (B) rotates in the opposite direction to the silicon roller (A) to force the adhesive composition between the rollers, down the well, through the gap (G) between the rollers and onto the surface of a panel (P) located beneath. As the machine bed, shown by (54) in FIG. 4, moves the panel (P) along the production line (in the direction of the arrow shown in FIG. 5) the adhesive composition is applied to the surface of the panel (P) via the silicon roller (A) at a coat weight corresponding to the gap (G) between the rollers.

It will be appreciated that the methods, materials and equipment/machinery described in relation to FIGS. 4 and 5 above, may be suitably modified by the skilled person to carry out a method according to the present invention.

1. A method of applying a paper sheet to a construction panel, the construction panel comprising an uneven outer surface, wherein the method comprises the steps of:
a) processing the construction panel to modify the uneven outer surface to provide:
(i) a uniform outer surface; and/or
(ii) a substantially uniform thickness across the entire construction panel;
b) applying an adhesive composition to the uniform outer surface to provide a construction panel bonding surface and/or applying an adhesive composition to the paper sheet to provide a paper bonding surface; and
c) bonding the paper sheet to the construction panel.

2. The method according to claim 1, wherein bonding the paper sheet to the construction panel comprises applying the paper sheet to the construction panel bonding surface.

3. The method according to claim 1, wherein the uneven outer surface comprises overlapping wood strands and a plurality of recesses formed between the overlapping wood strands.

4. The method according to claim 1, wherein the plurality of recesses in the uneven outer surface have a depth of from about 0.5 mm to about 20 mm and wherein the depth is decreased upon performing the step of processing the construction panel.

5. The method according to claim 1, wherein the construction panel is Oriented Strand Board (OSB) or Waferboard.

6. The method according to claim 3, wherein the overlapping wood strands are selected from the group consisting of spruce wood strands, fir wood strands, pine wood strands, larch wood strands, beech wood strands, aspen wood strands, birch wood strands, willow wood strands, alder wood strand or any combination thereof.

7. The method according to claim 1, wherein:
a) the method steps are performed continuously; optionally where the step of applying an adhesive composition to the uniform outer surface to provide the construction panel bonding surface is performed less than 30 minutes after the step of processing the construction panel; and/or
b) the adhesive composition is a hot melt adhesive; optionally when the adhesive composition is hot melt adhesive the adhesive composition may include waxes, resins, ethylene-vinyl acetate copolymers, polyolefins, polyamides, polyesters, polyurethanes, styrene block copolymers, polycaprolactones, polycarbonates, fluorinated polymers, silicone based polymers, polypyrroles or any combination thereof; and/or
c) the adhesive composition is applied at a coat weight of from about 20 to about 150 grams per square metre, preferably at a coat weight of from about 60 to about 100 grams per square metre.

8. The method according to claim 1, wherein the paper sheet is a building paper.

9. The method according to claim 8, wherein the building paper has:
i) a weight of from 50 grams per square metre to 400 grams per square metre; and/or
ii) a thickness of from 0.1 mm to 2 mm.

10. The method according to claim 1, wherein the step of processing the construction panel comprises sanding the uneven outer surface; optionally wherein the step of sanding comprises performing a step of calibration sanding and optionally followed by a step of finishing sanding.

11. The method according to claim 1, wherein:
a) the step of applying an adhesive composition to the uniform outer surface to provide a construction panel bonding surface is performed by spraying, brushing or roller coating the adhesive composition onto the uniform outer surface; and/or
b) applying the paper sheet to the construction panel bonding surface to bond the paper sheet to construction panel comprises applying a pressure of from about 20 kPA to about 800 kPa to the paper sheet; and/or
c) further comprising the step of selectively applying a further adhesive composition to a peripheral region of the construction panel bonding surface and/or selectively applying a further adhesive composition to a peripheral region of the paper sheet bonding surface before applying the paper sheet to the construction panel; and/or
d) applying the adhesive composition to the uniform outer surface is performed at a temperature of from about 50° C. to about 150° C.

12. The protected construction panel obtained or obtainable by the method of claim 1.

13. A paper lined construction panel comprising
an adhesive composition located on a uniform outer surface of the construction panel to form a bonding surface; and
a paper sheet located on the bonding surface;
wherein the construction panel is OSB or Waferboard and has a substantially uniform thickness across the entire construction panel.
